(19) United States
(12) Patent Application Publication
(10) Pub. No.: US 2007/0001530 A1
(43) Pub. Date: Jan. 4, 2007

(54) Motor mechanism

(75) Inventors: Shih-Kai Lin, Taoyuan Hsien (TW); Hung-Chi Chen, Taoyuan Hsien (TW); Te-Tsai Chuang, Taoyuan Hsien (TW); Wen-Shi Huang, Taoyuan Hsien (TW)

Correspondence Address: BIRCH STEWART KOLASCH & BIRCH, PO BOX 747, FALLS CHURCH, VA, 22040-0747, US

(73) Assignee: DELTA ELECTRONICS INC.

(21) Appl. No.: 11/476,074

(22) Filed: Jun. 28, 2006

(30) Foreign Application Priority Data
Jun. 30, 2005 (TW) 094122139

(51) Int. Cl. H02K 7/00; H02K 5/16

(52) U.S. Cl. 310/90; 310/67 R; 310/261

(57) ABSTRACT

A motor mechanism includes a stator, a first bearing, a second bearing, a sleeve and a rotor. The stator has an axial hole. The first bearing and the second bearing are respectively disposed in the axial hole. The sleeve is disposed in the axial hole and between the first bearing and the second bearing. The rotor has a shaft disposed in the axial hole and passing through the first bearing, the sleeve and the second bearing.

### BACKGROUND OF THE INVENTION

1. Field of Invention

The present invention relates to a motor mechanism, and more particularly, to a motor mechanism with a longer bearing lifetime.

2. Related Art

As shown in FIG. 1, a conventional motor mechanism 1 generally includes a stator 11, a first bearing 121, a second bearing 122, a spring 123 and a rotor 13. The stator 11 has an axial hole 111. The first bearing 121 and the second bearing 122 are ball bearings respectively disposed in the axial hole 111. The spring 123 is disposed adjacent to the first bearing 121. The rotor 13 has a shaft 131 disposed in the axial hole 111 and passing through in sequence the spring 123, the first bearing 121 and the second bearing 122.

Generally speaking, an inner ring side 121a of the first bearing 121 is located at the side close to the shaft 131 of the rotor 13, and an outer ring side 121b of the first bearing 121 is located at the side close to the stator 11. A plurality of balls 121c are disposed between the inner ring side 121a and the outer ring side 121b. Likewise, the second bearing 122 also has an inner ring side 122a and an outer ring side 122b, with a plurality of balls 122c disposed therebetween.

When the motor mechanism 1 is driven, the shaft 131 is tightly passing through the inner ring side 121a of the first bearing 121 and the inner ring side 122a of the second bearing 122. The inner ring side 121a of the first bearing 121 and the inner ring side 122a of the second bearing 122 are respectively connected with the outer ring side 121b of the first bearing 121 and the outer ring side 122b of the second bearing 122 via the balls 121c, 122c. Therefore, the first bearing 121 and the second bearing 122 can support the shaft 131 and provide necessary lubrication. When the rotor 13 rotates with respect to the stator 11 under a magnetic force of the motor mechanism 1, the shaft 131 rotates inside the axial hole 111. The balls 121c, 122c have to sustain the forces from the inner ring side 121a of the first bearing 121 and the inner ring side 122a of the second bearing 122. Therefore, when vibrations occur to the rotor 13 due to the rotation or the external force, the force may concentrate on the contact points of the balls 121c and the inner ring side 121a or the contact points of the balls 121c and the outer ring side 121b of the first bearing 121. The force may likewise fall on the contact points of the balls 122c and the inner ring side 122a or the contact points of the balls 122c and the outer ring side 122b of the second bearing 122. In those cases, the lifetime of the first bearing 121 and the second bearing 122 become shorter, thus resulting in the disorder of the motor mechanism 1.

It is thus imperative to provide a motor mechanism with a longer bearing lifetime.

### SUMMARY OF THE INVENTION

In view of the foregoing, the present invention provides a motor mechanism with a longer bearing lifetime.

To achieve the above, a motor mechanism according to the present invention includes a stator, a first bearing, a second bearing, a sleeve and a rotor. The stator has an axial hole. The first bearing, the second bearing and the sleeve are disposed in the axial hole, and the sleeve is disposed between the first bearing and the second bearing. The rotor has a shaft disposed in the axial hole and passing through the first bearing, the sleeve and the second bearing.

As mentioned above, by disposing a sleeve between the first bearing and the second bearing, a motor mechanism according to the present invention may fix the relative position of the first bearing and the second bearing. When the first bearing or the second bearing of the motor mechanism is under an external force, the force exerting on the first bearing (or the second bearing) is transmitted via the sleeve to the second bearing (or the first bearing). Thus, the external force is distributed, instead of falling on either the first bearing or the second bearing. Consequently, the structural disposition according to the present invention can ensure the stability of the bearings and elongate the lifetime of the motor mechanism.

### BRIEF DESCRIPTION OF THE DRAWINGS

The present invention will become more fully understood from the detailed description given herein below illustration only, and thus are not limitative of the present invention, and wherein:

FIG. 1 is a schematic view of a conventional motor mechanism;

FIG. 2 is a schematic view of a first embodiment of a motor mechanism according to the present invention;

FIG. 3 is another schematic view of the first embodiment of a motor mechanism according to the present invention;

FIG. 4 is a schematic view of a second embodiment of a motor mechanism according to the present invention; and

FIG. 5 is another schematic view of the second embodiment of a motor mechanism according to the present invention.

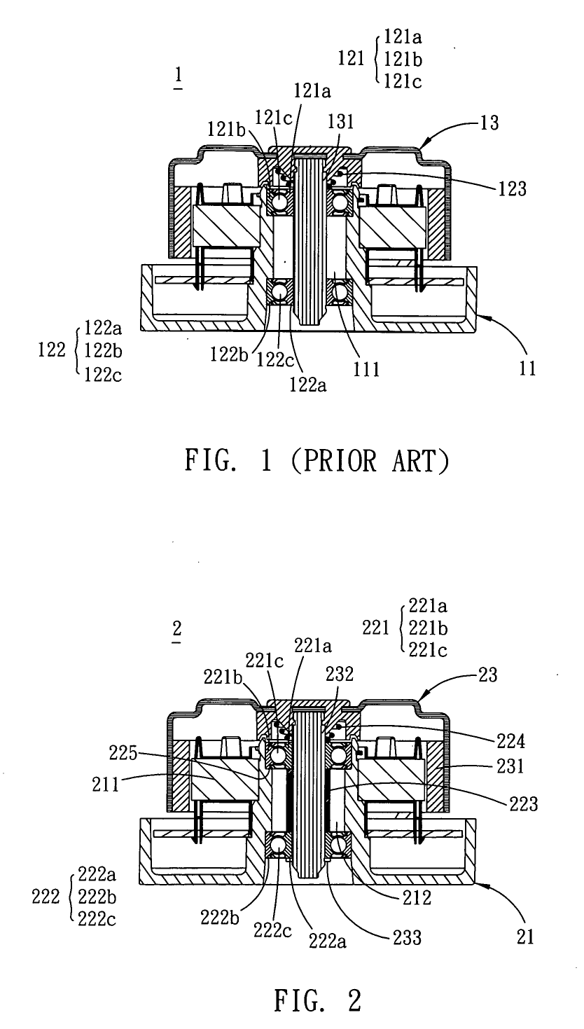

### DETAILED DESCRIPTION OF THE INVENTION

The present invention will be apparent from the following detailed description, which proceeds with reference to the accompanying drawings, wherein the same references relate to the same elements.

As shown in FIG. 2, a first embodiment of a motor mechanism 2 according to the present invention includes a stator 21, a first bearing 221, a second bearing 222, a sleeve 223 and a rotor 23.

The stator 21 has at least one coil 211 and an axial hole 212. In this embodiment, the inner wall of the axial hole 212 has a positioning portion 225, which may be a shoulder portion.

The first bearing 221 and the second bearing 222 are respectively disposed in the axial hole 212. In this embodiment, the first bearing 221 and the second bearing 222 are ball bearings. The first bearing 221 has a first inner ring side 221a, a first outer ring side 221b and a plurality of first balls 221c. The second bearing 222 has a second inner ring side 222a, a second outer ring side 222b and a plurality of second balls 222c.

In this embodiment, the first bearing 221 and the second bearing 222 are installed on the positioning portion 225 of the inner wall of the axial hole 212 by means of the first outer ring side 221b and the second outer ring side 222b.

The sleeve 223 is disposed in the axial hole 212 and between the first bearing 221 and the second bearing 222. In this embodiment, the sleeve 223 is a rigid sleeve with two ends respectively connected to the first inner ring side 221a of the first bearing 221 and the second inner ring side 222a of the second bearing 222. Besides, the two ends of the sleeve 223 may be respectively connected to the first outer ring side 221b of the first bearing 221 and the second outer ring side 222b of the second bearing 222 (not shown).

The rotor 23 has at least one magnet 231 and a shaft 232. The shaft 232 is disposed in the axial hole 212 and passing through in sequence the first bearing 221, the sleeve 223 and the second bearing 222. A positioning piece 233 is used to prevent the shaft 232 separating from the second bearing 222. The magnet 231 and the coil 211 of the stator 21 construct a magnetic field for the rotor 23 to rotate with respect to the stator 21. Currently, there are other types of stators and rotors that enable the rotors to rotate with respect to the stator. Such details are well-known to the person skilled in the art and will not be further described herein.

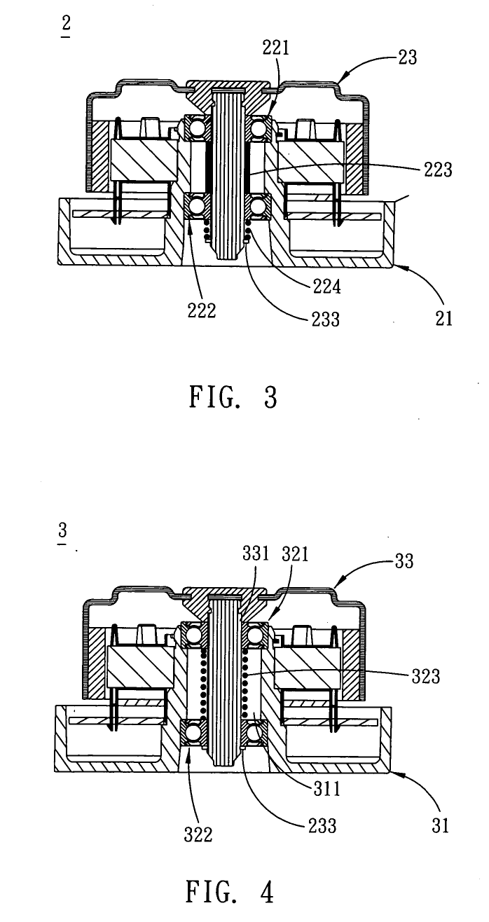

The motor mechanism 2 further includes a buffer element 224 mounted on the shaft 232 and adjacent to the first bearing 221. Moreover, as shown in FIG. 3, the buffer element 224 can be mounted on the shaft 232 and adjacent to the second bearing 222. More preferably, the buffer element 224 is mounted between the second bearing 222 and the positioning piece 233. Furthermore, the buffer element 224 may be respectively disposed adjacent to the first bearing 221 and the second bearing 222 (not shown). In this embodiment, the buffer element 224 is a spring, an elastic piece, a retractable sleeve, a sponge sleeve, a rubber sleeve, the combination thereof, or any other element with the buffering function.

As shown in FIGS. 2 and 3, when the rotor 23 rotates with respect to the stator 21 under a magnetic force of the motor mechanism 2, the shaft 232 drives the first inner ring side 221a of the first bearing 221 and the second inner ring side 222a of the second bearing 222 to rotate inside the axial hole 212.

Since the sleeve 223 is connected to the first inner ring side 221a of the first bearing 221 and the second inner ring side 222a of the second bearing 222, the relative position of the first bearing 221 and the second bearing 222 is thus fixed. When the shaft 232 rotates, the contacts between the inner ring sides 221a, 222a and the balls 221c, 222c of the first and second bearings 221, 222 remain uniform, so that the first and second bearings 221, 222 are less likely to be damaged due to vibrations.

Moreover, when the motor structure 2 sustains collisions or knocks, the external force acting on the first bearing 221 (or the second bearing 222) is transmitted to the second bearing 222 (or the first bearing 221) via the sleeve 223. Such an external force is then alleviated by the buffer element 224 disposed with the first bearing 221 or the second bearing 222. Therefore, the external force does not concentrate solely on either the first bearing 221 or the second bearing 222. This ensures the stability and lifetime of the first bearing 221 and the second bearing 222, and raises the reliability of the motor mechanism 2.

As shown in FIG. 4, a second embodiment of a motor mechanism 3 according to the present invention includes a stator 31, a first bearing 321, a second bearing 322 and a rotor 33. The stator 31, the first bearing 321, the second bearing 322 and the rotor 33 are generally the same as the first embodiment. The first bearing 321 and the second bearing 322 construct a bearing structure 32. The main difference between the second embodiment and the first embodiment is the bearing structure 32 has a sleeve 323. In this embodiment, the sleeve 323 is an elastic sleeve disposed in an axial hole 311 of the stator 31. Two ends of the sleeve 323 are respectively connected to the first bearing 321 and the second bearing 322. Therefore, the sleeve may not only keep the relative position of the first bearing 321 and the second bearing 322, but also provide the function of buffering the external force. Besides, the sleeve 323 in this embodiment may be a spring, an elastic piece, a retractable sleeve, a sponge sleeve, a rubber sleeve, the combination thereof, or any other element with the buffering function. The installation of the sleeve 323 has all kinds of variations as the sleeve 223 in the first embodiment, and is not further described herein.

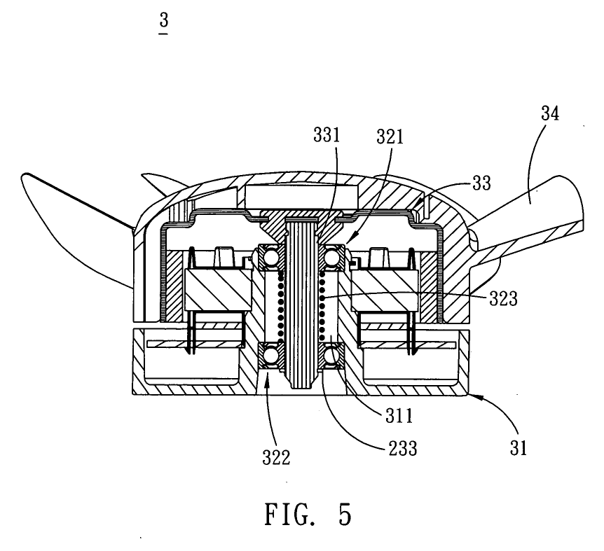

Finally, as shown in FIG. 5, the motor mechanism 3 may cooperate with an impeller. The impeller is disposed on the rotor 33 and has at least one blade 34 disposed on the outer rim of the rotor 33. Therefore, when the rotor 33 rotates with respect to the stator 31, the blade 34 is also rotated to generate an air stream.

To further enhance the buffering function, this embodiment may dispose one buffer element adjacent to the first bearing 321 or the second bearing 322, as shown in FIGS. 2 and 3. It may even dispose two buffer elements respectively adjacent to the first bearing 321 and the second bearing 322.

In summary, by disposing a sleeve between the first bearing and the second bearing, a motor mechanism according to the present invention may fix the relative position of the first bearing and the second bearing. Comparing with the prior art, the contacts between the inner ring sides and the balls of the first and second bearings are more uniform. The bearings are less likely to be damaged due to vibrations. Besides, when the first bearing or the second bearing of the motor mechanism is under an external force, the force exerting on the first bearing (or the second bearing) is transmitted via the sleeve to the second bearing (or the first bearing) while the sleeve is a rigid sleeve. Thus, the external force is distributed, instead of falling on either the first bearing or the second bearing. The buffer element is disposed on either the first bearing or the second bearing to further provide a buffering effect. If the sleeve is an elastic sleeve, the force exerting on the first bearing or the second bearing is transmitted to the sleeve to achieve a buffering effect in both directions. Consequently, the structural disposition according to the present invention can ensure the stability of the bearings and elongate the lifetime of the motor mechanism.

Although the present invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the present invention.

What is claimed is:

1. A motor mechanism, comprising:
a stator having an axial hole;
a first bearing disposed in the axial hole;
a second bearing disposed in the axial hole;
a sleeve disposed in the axial hole and between the first bearing and the second bearing; and
a rotor having a shaft disposed in the axial hole and passing through the first bearing, the sleeve and the second bearing.

2. The motor mechanism according to claim 1, further comprising a buffer element mounted on the shaft and adjacent to the first bearing.

3. The motor mechanism according to claim 2, wherein the buffer element is a spring, elastic piece, retractable sleeve, sponge sleeve or rubber sleeve.

4. The motor mechanism according to claim 1, wherein the shaft is fixed by a positioning piece after passing through the second bearing to prevent the shaft separating from the second bearing.

5. The motor mechanism according to claim 4, further comprising a buffet element mounted on the shaft and adjacent to the second bearing.

6. The motor mechanism according to claim 5, wherein the buffer element is disposed between the second bearing and the positioning piece.

7. The motor mechanism according to claim 5, wherein the buffer element is a spring, elastic piece, retractable sleeve, sponge sleeve or rubber sleeve.

8. The motor mechanism according to claim 1, wherein the first bearing or the second bearing is a ball bearing.

9. The motor mechanism according to claim 8, wherein the first bearing has a first inner ring side, a first outer ring side and a plurality of first balls, and the second bearing has a second inner ring side, a second outer ring side and a plurality of second balls.

10. The motor mechanism according to claim 9, wherein two ends of the sleeve are respectively adjacent to the first inner ring side of the first bearing and the second inner ring side of the second bearing.

11. The motor mechanism according to claim 9, wherein two ends of the sleeve are respectively adjacent to the first outer ring side of the first bearing and the second outer ring side of the second bearing.

12. The motor mechanism according to claim 1, wherein the sleeve is an elastic sleeve or a rigid sleeve.

13. The motor mechanism according to claim 12, wherein the elastic sleeve is spring, elastic piece, retractable sleeve, sponge sleeve or rubber sleeve.

14. The motor mechanism according to claim 1, wherein one end of the first bearing or the second bearing is connected to a positioning portion.

15. The motor mechanism according to claim 14, wherein the positioning portion is disposed on the inner wall of the axial hole.

16. The motor mechanism according to claim 14, wherein the positioning portion is a shoulder portion.

17. The motor mechanism according to claim 1, wherein an impeller is disposed on the rotor.
